(19) United States
(12) Patent Application Publication
(10) Pub. No.: US 2007/0278451 A1
(43) Pub. Date: Dec. 6, 2007

(54) White light LED, enhanced light transfer powder, phosphor powder and method of producing phosphor powder

(75) Inventor: Soshchin Naum, Changhua City (TW)

Correspondence Address: John G. Chupa;Law Offices of John Chupa & Associates, P.C., Suite 50, 28535 Orchard Lake Road, Farmington Hills, MI, 48334, US

(73) Assignee: Shian-Meng Chen Tsai

(21) Appl. No.: 11/701,638

(22) Filed: Feb. 2, 2007

(30) Foreign Application Priority Data
Jun. 6, 2006 (TW) 095119977

(51) Int. Cl. C09K 11/08; C09K 11/02; C09K 11/66; C09K 11/77

(52) U.S. Cl. 252/301.4 F; 252/301.4 R

(57) ABSTRACT

The invention discloses a white light LED, an enhanced light transfer powder, a phosphor powder and a method of producing phosphor powder that use a plurality of radiating color lights and include a white light nitride heterostructure. The invention provides a novel solid liquid of a luminescence material with a chemical formula Ba_{α}Y_{3β}Al_{2α+5β}O_{4α+12β}, where α and β have a value ranging 0.1˜4. The crystal lattice structure of the phosphor powder varies from cubic crystal system to monoclinic crystal system accroding to the change of the ratio of α and β. It shows significant yellow color and yellowish orange color and has very high quantum light emitting efficiency and enduring light emitting time. In such novel phosphor powder base, the invention further develops an enhanced light transfer apparatus that is a blue light heterostructure emiting a raidaion with a wavelength λ=450˜475 nm and comprised of polymers and phosphor powder particles filled therein, and the concentration of phosphor powder is 1%˜50%. The novel white semiconductor source has a very high light intensity (I>100 cd) and luminous flux, and its light emitting efficiency is up to 501 m/w.

### BACKGROUND OF THE INVENTION

1. Field of the Invention

The present invention relates to a white light emitting diode (LED), an enhanced light transfer powder, a phosphor powder and a method of producing phosphor powder, and more particularly to a white light LED, an enhanced light transfer powder, a phosphor powder and a method of producing phosphor powder that apply several white light nitride heterostructures capable of emitting color lights to show the features of a strong yellow color and a yellowish orange color that have a high quantum light emitting efficiency and a durable light emitting time.

2. Description of the Related Art

Since 1968, the light emitting diode technology has started using phosphor powder and a specturm conversion structure that uses phosphor powders as a base extensively. At early times, a converter that improves the light emitting efficiency makes use of the effect of an anti-Stokes phosphor powder to convert the near infrared light of GaAsP diodes into a red light or a green light (refer to Berg, Din A., LED, <<Mir>>, 1975). Thereafter, many researchers tried to convert the weak ultraviolet light of GaN diodes into a visible light.

The experts (including S. Nakamura and S. Shimizu) of Nichia Company have achieved breakthroughs in the researches of this subject and developed a new light source by the blue light of a GaInN heterostructure and a yellow alumium yttrium garnet phosphor powder (Y₃Al₅O₁₂) (refer to German Pat. No. DE6933829T issued to S. Nakamura on Nov. 5, 2006 and R.O.C. Pat. No. TW156177B issued to S. Shimizu Y on Nov. 1, 2005).

The acheivements of these two paented inventions are applied to the illumination, lamp decoration and indicating purpose of the white light emitting diode. Refer to the patent specification (R.O.C. Pat. No. TW156177B issued to S. Shimizu Y. on Nov. 1, 2005), the use of aluminum yttrium garnet phosphor powder in light emitting diodes is described in details. However, we do not believet that such invention is novel, and the novelty of its prototype mentioned in the specification include: 1. using a GaInN heterostructure that emits a blue light as the structural foundation of light emitting diodes; 2. adopting phosphor powder particles with an enhanced light transfer effect in light emitting diodes; 3. mixing two portions of emitting lights such as the direct light emission of the GaInN semiconductor heterostructure and the light emission activated by the phosphor powder particles to produce a white light; and 4. adopting an aluminum yttrium garnet with a chemical formula Y₃Al₅O₁₂:Ce and its derivative such as a phosphor powder composed of (Y,Gd)₃(Al,Ga,Sc)₅O₁₂:Ce particles. There are many journals and literatures regarding the GaInN semiconductor heterostructure that emits blue lights, but S. Nakamura and G. Fasol et al have made technical disclosures on 1998 (refer to S. Nakamura and G. Fasol, The blue laser diodes. Berlin, Springer, 1998) and cited a portion of the GaInN semiconductor heterostructure that emits blue lights. The achievement of a high performance light emitting nitride heterostructure produced accroding to the quantum effect of S. Nakamura's study has become a public domain, and all of these are considered as Nichia Company's efforts and contributions. As mentioned above, the enhanced light transfer powder used for light emitting diodes is made of an anti-Stokes material (refer to Berg, Din A., LED, <<Mir>>), 1975) and gone through a skillful technique. A short wave radiation used for activating various different matters to emit lights has been described in details in many acacemic theses (refer to P. Pringshein, Phluorescence and phosphorescence, IL, 1950; G. Blasse, P. Grabmaier, Luminescence materials, Pergamon press, NY, 1995; and S. Shionoja, W. Yen, Handbook of phosphors, NY, 1999). We believe that the method of using a light emitting diode to emit short wave radiations to obtain long-band radiations from phosphor powders is not novel or has any significant feature. There are many light sources for emitting ligth by activating other matters, and these light sources include gas discharge light sources: 1. gas discharge of mercury vapor; 2. gas discharge of nitrogen; and 3. gas discharge of xenon and krypton. In addition, laser radiations are used extensively for activating phosphor powders to emit lights such as nitrogen lasers and Nd:YAG lasers for outputting third harmonic waves and fourth harmonic waves.

The solution of using semiconductor light emitting diodes to activate phosphor powders has been mentioned for more than one time (refer to S. Nakamura and G. Fasol, The blue laser diodes. Berlin, Springer, 1998).

The related matters of combining two or more basic light sources to obtain a white light are described below. The physical base of combining monochromatic lights such as blue light and yellow light, green light and red light, red light, green light and blue light obtained from the occurrence of a dispension of color to produce a white light was established by Newton and developed from Newton's light color theory. The phsycial principle was used extensively in the areas of printing and photography and particularly in black-and-white and color television technologies during the 19^{th} and 20^{th} centuries. Vladimir Zworykin's black-and-white cathode ray tube utilizes a blue color light and a yellow color light as two basic lights to emit a white light (refer to H. W. Leverenz, An introduction to Luminescence of Solids, NY, 1950), and it is a complicated technical solution for color television technology, not only requiring primary color lights that have complete chromatic aberration coefficients, but also requiring a compensation of primary colors to obtain a white ligth that can meet the standards of color chromaticity.

In the technical field of illuminations, the problem similar to the foregoing physical theory has been solved (refer to L. M. Kogan LED lighttechnic, Moscow, Ho. 5, pp. 16-20 (2002)): a mercury vapor discharge emits a blue color light and activates YVO₄:Eu to emit a red color light and finally produces a white light similar to a white light source. The short wave discharge of xenon and krypton assures that the gas discharge ion panel can produce red, green, blue white color lights. Therefore, the technological advance of using a semiconductor light emitting diode to replace a gas discharge light source to activate the phosphor powders and emit lights for perfect illuminations, information, indicating system becomes a trend.

The blue light source for producing different optical effects can be used extensively. The blue light source for producing long afterglows and super long afterglows is used extensively in the radar positioning technology. The original blue light and yellowish white afterglow optics of a light emitting display device are integrated organically into a device.

Therefore, the physical theory of a white light free of chromatic aberration and syntheszed with two or three light sources has been disclosed and used publicly before Nichia Company announced its research achievements.

The use of yttrium aluminum garnet as a luminescence material causes many ligitations, because only Nichia Company has the right of using such material (and thus a new research direction shows up, and a luminescence material other than the yttrium aluminum garnet is used for light emitting diodes), and such right was proven later as lack of legal grounds. Firstly, the luminescence materials and display devices made of a yttrium aluminum garnet have been disclosed earlier in the research achivements by Japanese researchers (refer to G. Blasse, P. Grabmaier, Luminescence materials, Pergamon press, NY, 1995; S. Shionoja, W. Yen, Handbook of phosphors, NY, 1999.; H. W. Leverenz, An introduction to Luminescence of Solids, NY, 1950 and V. A. Abramov, patent USSR No. 635813, Sep. 12, 1977). The chemical material Y₃Al₅O₁₂ or (Y,Gd)₃(Al,Ga)₅O₁₂:Ce is used extensively in a high speed cathode ray tube techology to detect black-and-white or color films. The blinking devices using powder yttrium aluminum garnets or single crystal yttrium aluminum garnets as its structureal base are applied in nuclear physics and nuclear technology. In the meantime, the physcial correction technology of spectrum is also used, and the main physcial properties of the YAG luminescence material include the features of a high light emitting efficiency, a very short afterglow, a hightly reliable luminous flux and power, and emitting bluish green color, green color, yellow color and orange color in the bands of visible lights. Such technology has been used at earlier time before Nichia Company applied garnet phosphor powders to light emitting diodes. Therefore, we believe that the research achievements of the garnet phosphor powder made by Nichia's experts have not exceeded a reasonable level of knowledge for the direct use of phosphor powder. In the meantime, it lacks of legal grounds to include all light emitting materials that use cerium as an activator in Nichia's patent rights. The well-known luminescence materials such as orthosilicates of Al₂O₃:Ce, gelenite:Ce, yttrium, gadolinium, and lutetium and pyrosilicates of Y₂Si₂O₅:Ce, Gd₂SiO₅:Ce, and Lu₃Si₂O₇:Ce are used extensively in the production related to the flurorescence technology and definitely are not related to the Nichia Company's patented invention in practical applications.

Based on the foregoing analysis, the following conclusions are drawn: 1. The technology of using phosphor powders and enhanced light transfer apparatuses in various different types of light emitting diodes has been disclosed and known at an earlier time. 2. The method of combining two or more basic lights to produce a white light is well known in the art, and its physics and color chromaticity theory are obvious. 3. The main composition of luminescence material that uses cerium as an activator for a yttrium aluminum garnet compound has been disclosed in 1965 which is much earlier than the Nichia Company's invention. 4. The Ce⁺³ is used for activating a luminescence material of various different crystal structures. 5. The Nichia Company's garnet phosphor powder related patents are not novel, and these patented inventions are technical solution of using a blue color light to achive a white light only, which is definitely a blemish.

### SUMMARY OF THE INVENTION

In view of the shortcomings of the prior art, the inventor of the present invention based on years of experience in the related industry to conduct extensive researches and experiments, and finally invented a white light emitting diode (LED), an enhanced light transfer powder, a phosphor powder and a method of producing phosphor powder in accordance with the present invention.

Therefore, it is a primary objective of the present invention to provide a feasible solution and overcome the foregoing problems by providing a white light LED, an enhanced light transfer powder, a phosphor powder and a method of producing phosphor powder that can be applied to light emitting diodes and have new componsitions and features.

Another objective of the present invention is to provide a white light LED, an enhanced light transfer powder, a phosphor powder and a method of producing phosphor powder that can selectively adopt a nitride heterostructure with a radiation wavelength from 440 nm to 475 nm as a good composition for producing phosphor powders that radiate various color temperatures.

A further objective of the present invention is to provide a white light LED, an enhanced light transfer powder, a phosphor powder and a method of producing phosphor powder selectively used as an enhanced light transfer material for a nitride heterostructure.

Another further objective of the present invention is to provide a white light LED, an enhanced light transfer powder, a phosphor powder and a method of producing phosphor powder that optimize the overall structure including an optical thickness of an enhanced light transfer layer of the light emitting diode and a component filled or submerged in the internal chamber of the light emitting diode.

To achieve the foregoing objectives, a phosphor powder in accordance with the invention applied in a white light LED that uses an oxide of Groups II or III element in the periodic table as a substrate, and an element with an electron jump from d orbital to f orbital as an activator, and the substrate of the phosphor powder is composed of solid solutions of barium and yttrium aluminates, and its chemical formula is Ba_{α}Y_{3β}Al_{2α+5β}O_{4α+12β}, and the crystal system of its crystal lattice varies with the ratio of barium to yttrium. If the substrate is activated by a short wave radiation, the ions of the element radiates a greenish orange color light mixed with a short wave radiation produced by an indium gallium nitride semiconductor heterostructure to form a white light.

To achieve the foregoing objectives, a white light LED in accordance with the invention comprises an InGaN semiconductor heterostructure and an enhanced light transfer powder, wherein the enhanced light transfer powder is comprised of a polymer substrate and phosphor powders, and the degree of polymerization of its structural base is equal to 100˜500, and the molecule quality is larger than an epoxy resin or an organosilicon resin having 5000 standard carbon units, and 1%˜50% of phosphor powder is filled to form a polymer layer with an even thickness on the light emitting surface of the heterostructure, and this layer can convert the original radiation of the short wave heterostructure into a white light with a ratio color temperature from 3200K to 6000K, and the color chromaticity of its emitted light is Ra≧85.

To achevie the foregoing objective, a method of producing phosphor powder in accordance with the present invention comprises the steps of: performing a solid phase sintering for oxides and carbonates; continuing the solid phase sintering for several hours in a high temperature environment; and performing an ignition at a high temperature in a reduction environment.

To achevie the foregoing objective, a method of producing phosphor powder in accordance with the present invention comprises the steps of: using hydroxides as raw materials; and adding and mixing the hydroxides with an approriate proportion into a melted barium hydroxide.

### BRIEF DESCRIPTION OF THE DRAWINGS

FIG. 1 is a flow chart of a method of producing phosphor powder according to a preferred embodiment of the present invention;

FIG. 2 a flow chart of a method of producing phosphor powder according to another preferred embodiment of the present invention;

Attachment 1 shows a spectrum-color temperature feature of a solid solution synthesized of ¼ m of BaAl₂O₄ and 1 m of Y₃Al₅O₁₂; and

Attachment 2 shows a light emitting spectrum of a phosphor powder synthesized of 0.5 m of BaAl₂O₄ and 1 m of Y₃Al₅O₁₂ and activated jointly by Ce⁺³ and Pr⁺³.

### DETAILED DESCRIPTION OF THE PREFERRED EMBODIMENTS

The present invention provides a novel phosphor powder and its basic enhanced light transfer powder, and the phosphor powder uses an oxide of Groups II and III element in the periodic table as a substrate, and a d˜f element as an activator having the following characteristics: The substrate of phosphor powder is composed of solid solutions of barium and yttrium aluminates or their equivalents, and the chemical formula is Ba_{α}Y_{3β}Al_{2α+5β}O_{4α+12β}, wherein α has a value within the range of α≦1 or α≦1, and β has a value within the range of β≦1 or β≧1. The cyrstal system of the crystal lattice varies with the ratio of barium to yttrium. If α≦0.1, the crystal lattice is a cubic crystal system; if α=1, β≦0.1, the the crystal lattice will be a hexagonal crystal system; and if α=1, β=1.0, the crystal lattice will be a monoclinic crystal system. A f element and a d element such as Ce, Pr, Eu, Dy, Tb, Sm, Mn, Ti or Fe is added into the foregoing compound, and these elments have different oxidation levels within +2˜+4. If the substrate compound is activated by a short wave radiation with λ≦470 nm, the foregoing ions will emit a greenish orange color light with a wavelength λ=530 nm˜610 nm mixed with a short wave radiation emitted by the indium gallium nitride semiconductor heterostructure to produce a white light.

As to the physical chemistry, the experiements of the present inveniton show that aluminates of Group II elements such as MeAl₂O₄ (if Me=Mg or Ca, a compound MgAl₂O₄ with a spinel type and a cubic crystal system is formed) or a compound Me₄Al₇O₁₅ have similar optical properties of the yttrium aluminate. If these compounds are activated by Ce⁺³ ions, a strong light will be emitted, and a light beam with λ=450˜470 nm will be activated by the blue light diodes.

The experiments of the invention also show that if a solid solution is formed by mono aluminates and poly aluminates of Group II elements and Y₃Al₅O₁₂ garnet type yttrium aluminates or calcium titanium YAlO₃ type yttrium aluminates, the emitting light will be stronger. The composition of this solid solution contains integral MeAl₂O₄ type mono aluminate. For instance, a unit yttrium aluminum garnet may contain 1, 2, 3 or 4 units of mono aluminates. However, it may contain a solid solution with a non-integral unit of mono aluminates, such as MeAl₂O₄ may have a number of 0.1, 0.25, 0.4 or 0.5. The solid solution formed by aluminates of Group II element and yttrium aluminate may contain less yttrium aluminate. Under this situation, if α=1, β≦0.1, a crystal structure of the solid solution will be substantially a hexagonal crystal system; if α≦0.1, β=1, the crystal structure will bve substantially a typical cubic crystal system of the yttrium aluminate garnet. Now, the parameter of the cystal lattice approaches a=12.4A°, which is larger than the parameter of the cystal lattice of the standard yttrium aluminum garnet. However, Ce⁺³ ions in the crystal lattice with this parameter can be dissolved more easily (its solubility may be over 15%, and the average solubility of Ce₂O₃ in the standard yttrium aluminum garnet does not exceed 3%).

If α≦1, and β≦1, the crystal lattice structure of the solid solution will be loose, which belongs to a monoclinic crystal system (a,b,c, γ).

The solid solution formed by aluminates of Group II elements and yttrium aluminates can dissolve larger ions such as Ce⁺³ very well. The ions of light rare earth elements including Ce⁺³ and Pr⁺³ can be dissolved in the solid solution very easily. The ions of heavy rare earth elements including Dy⁺³, Tb⁺³ and Eu⁺³ and the Sm⁺³ at a borderline can be dissovled in the solid solution. Now, the Eu⁺² and Sm⁺² having a variable valence state may simultaneously have two different oxidation states: +2 valence state and +3 valence state, and Mn⁺² and Mn⁺⁴, Ti⁺³ and Ti⁺⁴, Fe⁺² and Fe⁺³ may exist simultaneously or seprately in a crystal lattice structure of the solid solution. The foregoing ions have the property of emitting strong lights (wherien the ion such as Ti⁺³ gaining this light emitting property again). The bands of the lights activated by all of the foregoing ions (Dy⁺³, Tb⁺³, Mn⁺⁴ and Ti⁺³) with a strong light emission is close to a near ultraviolet band or a blue light band with λ=440 nm in a visible light spectrum.

The present invention performs a detail analysis of the radiating spectrum of the d element and f element syntheized in the solid solution as shown in Attachment 1. Attachment 1 shows a spectrum-color temperature composed of a solid solution synthesized by ¼ m of BaAl₂O₄ and 1 m of Y₃Al₅O₁₂. The most significant characteristic of emitting light activated by the Ce⁺³ includes a bell-curve spectrum having a larger half width value of spectrum.

Attachment 2 shows a light emitting spectrum actiavated jointly by Ce⁺³ and Pr⁺³ in the phosphor powder which is synthesized by 0.5 m of BaAl₂O₄ and 1 m of Y₃Al₅O₁₂. The characteristic resides on that Pr is a +3 valence state ion, and its light emitting spectrum is situated at a long wave band at λ=610 nm˜615 nm.

The foregoing novel compound that uses several activators has the following advantages: 1. The band covered by the light emitting spectrum of phosphor powder is wider than the previous one. 2. A small quantity of second or third kind of activator is added to change or modifiy the original color of the emitted light. 3. A light of a different frequency can be selected for the activation to change the color of light emitted by the phosphor powder.

The stoichiometric parameters α and β can have arbitrary values to achieve the aforementioned advantages, and the performance is even better for 1 m of Y₃Al₅O₁₂ if α=0.25 and α=0.5. The crystal lattice of the substrate of phosphor powder is a cubic crystal system, and the compounds BaAl₂O₄ and Y₃Al₅O₁₂ are activated by Eu⁺² and/or Ce⁺³ respectively and dissoved to produce a fluorescent substance.

If the stoichiometric parameters α=1 and β≦0.1, a phosphor powder with the chemical formula BaY_{0.3}Al_{2.5}O₅₂ will be formed and activated by duad rare earth element ions Eu⁺2 and Sm⁺² to produce a narrow band bluish green color light in the spectrum, and the half width ≦λ_{0.5}=60˜70 nm. The substrate of phosphor powder has an orthorhombic crystal structure. After a blue color light with λ=460 nm is activated by the heterostructure, a strong bluish green color light with chromaticity coordinates x=0.17˜0.22 and y=0.45-0.55 is emitted.

Besides the traditional activator of Ce⁺³, the Ti⁺³ and Fe⁺³ can be dissolved in a substrate of phosphor powder, such that the radiation peak value of phosphor powder can be increased to 125˜130 nm, the chromaticity coordinates of x≦0.40 and y≦0.45 feature a reddish orange color.

If BaAl₂O₄ with a stoichiometric parameter α≦1 is added to the substrate of phosphor powder, the solid solution cyrstal has the structure of an orthorhomic crystal system. Therefore Gd⁺³ can be used to substitute the portion of y⁺³, and the radiation peak value of phosphor powder shifts towards a long wave having a band from λ=558 nm to λ≦570 nm. The summation of chromaticity coordinates of the emitted light is Σ(x+y)≧0.80. A sample of this phosphor powder shows an advantage of emitting red color light at a high temperature.

The stoichiometric parameters α and β vary within the range of α/β≧2, so that the color of the syntheized phosphor powder will be darkened. If α=1 and β=1, the phosphor powder will show a light yellow color, which is close to a yellow color of grass, and the value of α will be increased to change the color to a gold color. The miniumum radiation absorbed by the phosphor powder shows up at the band with λ=440˜480 nm, and the maximum light reflection at a band with λ≧560 nm can be up to R=90%˜95%.

As mentioned in the previous section, Sr⁺² or Ca⁺² can be used to substitute the portion of Ba⁺² in a cation sub crystal lattice. The substrate of phosphor powder can be activated by Eu⁺², Sm⁺² or Mn⁺² to produce a narrow band radiation with Δλ=100˜110 nm at a band of 505 nm˜585 nm in the spectrum.

In the present invention, the features of lights emitted by the phosphor powder are studied. If the stoichiometric parameters α=1 and β≦0.5, the afterglow of the light emitted by the phosphor powder will be tₑ=100˜150 ns, and if β/α≧4, the afterglow will be decreased to t=40˜50 ns.

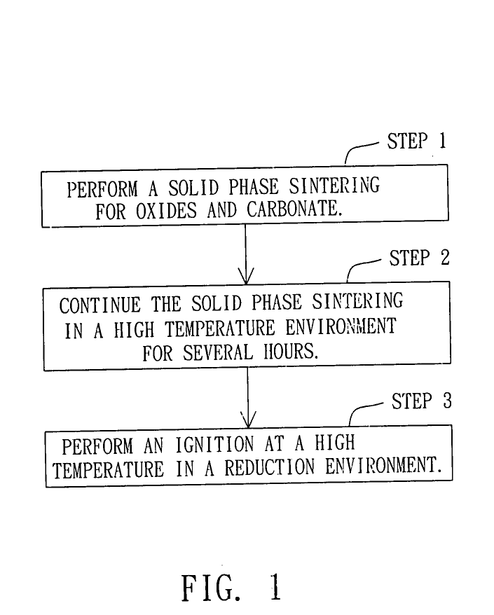

There are many solutions for synthezing this kind of phosphor powder in accordance with the invention. Referring to FIG. 1 for the flow chart of a method of producing phosphor powder in accordance with a preferred embodiment of the present invention, the method comprises the steps of: performing a solid phase sintering for oxides and carbonates (Step 1); continuing the solid phase sintering at a high temperature environment for several hours (Step 2); and performing an ignition in the reduction environment at a high temperature (Step 3).

In Step 1, a solid phase sintering is performed for the oxides and carbonate, wherien the oxides include Y₂O₃, Al₂O₃ and Ce₂O₃, and the carbonate is BaCO₃.

In Step 2, the solid phase sintering is continued for several hours in a high temperature environment, wherein the high temperature environment is from 1100° C. to 1500° C. and the sintering is continued for 2˜10 hours.

In Step 3, an ignition is performed at a high temperature in a reduction environment, wherein the reduction environment is conducted at H₂:N₂=1:20.

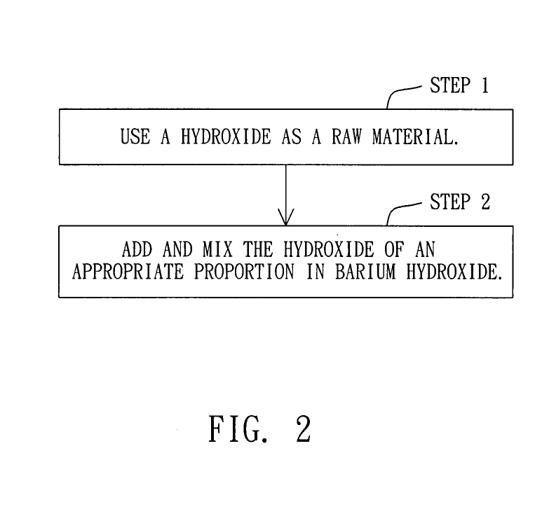

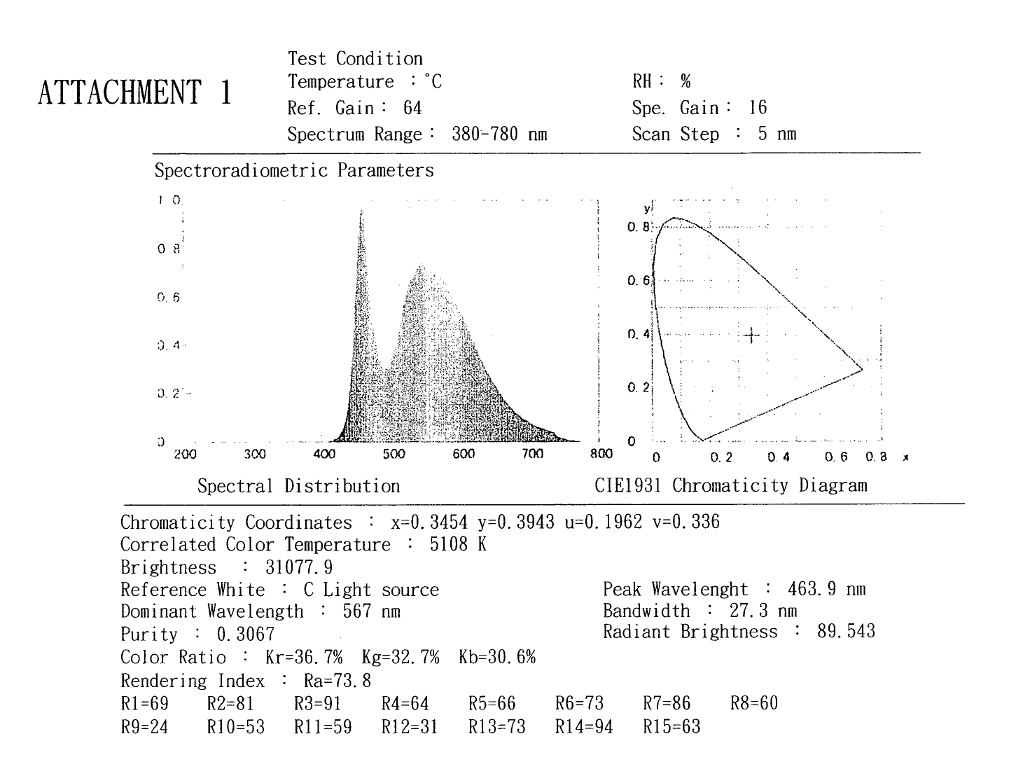

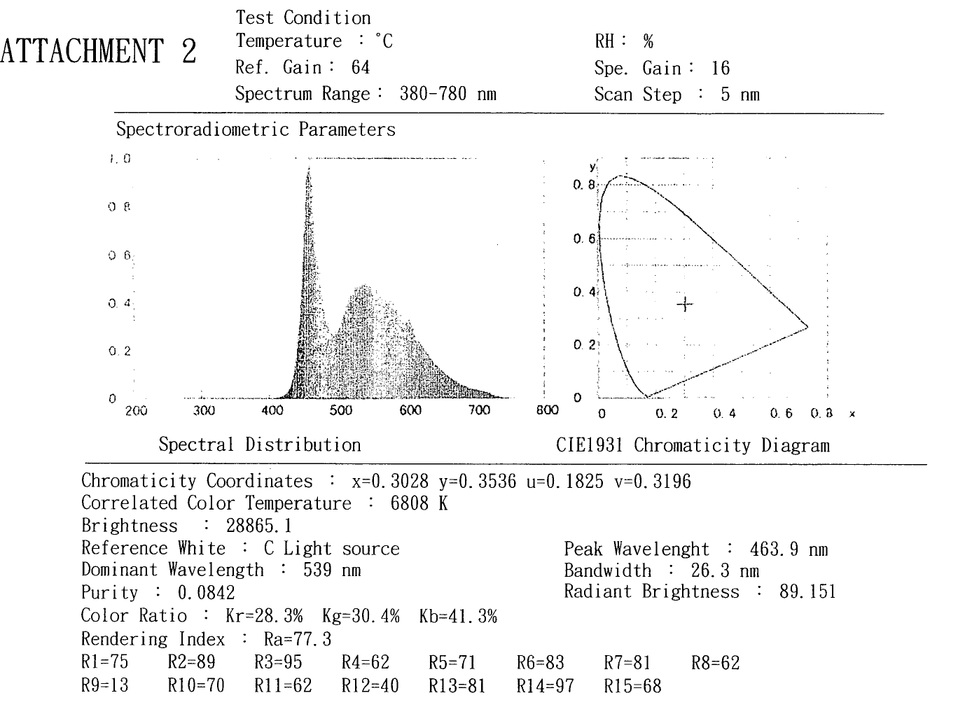

Referring to FIG. 2 for the flow chart of a method of producing phosphor powder in accordance with another preferred embodiment of the present invention, the method comprises the steps of: using hydroxides as raw materials (Step 1); and adding the hydroxides with an appropriate proportion into a melted barium hydroxide and mixing the hydroxides (Step 2).

In Step 1, hydroxides are used as raw materials, wherein the hydroxides include Ba(OH)₂.8H₂O, Sr(OH)₂.8H₂O, Al(OH)₃ and Y(OH)₃, etc.

In Step 2, the hydroxides with an appropriate proportion is added into the melted barium hydroxide and mixed thoroughly, wherien the phosphor powders produced by such chemical melting method show a solid solution form and achive a higher parameter of a light emission of equivalent quality. Table 1 lists the parameters of the compound obtained by the melting method.

TABLE 1

| | | | | Peak | |
|---|---|---|---|---|---|
| | | | | Wavelength | |
| | | | | when | |
| | stoichiometric | | | Ce⁺³ is | |
| | parameter | | Crystal Lattice Structure | initiated | |
| | α | B | Types | (nm) | x, y |
| 1 | 1.0 | 0.1 | orthorhomic crystal | 530 | 0.29, 0.32 |
| | | | system | | |
| 2 | 1.0 | 0.25 | hexagonal crystal system | 540–55- | 0.35, 0.39 |
| 3 | 1.0 | 0.5 | hexagonal crystal system | 545–560 | 0.36, 0.42 |
| 4 | 1.0 | 1.0 | monoclinic crystal | 560–570 | 0.38, 0.42 |
| | | | system | | |
| 5 | 0.75 | 1.0 | hexagonal crystal system | 540–560 | 0.34, 0.38 |
| 6 | 0.5 | 1.0 | Pseudo-cubic crystal | 535–585 | 0.30, 0.45 |
| | | | system | | |
| 7 | 0.25 | 1.0 | Cubic crystal system | 545–585 | 0.38, 0.44 |
| 8 | 0.1 | 1.0 | cubic crystal system | 550–560 | 0.36, 0.42 |
| 9 | 2.0 | 1.0 | orthorhomic crystal | 545–575 | 0.33, 0.43 |
| | | | system | | |
| 10 | 0.10 | 4.0 | cubic crystal system | 535–575 | 0.30, 0.45 |

The phosphor powder particles produced in the melting method is substantially in a sheet form, and the change of particles is shown in its linear dimension of a plane (1 μ˜20 μ), and the change of thickness (1.5 μ˜2 μ) is not large. The structure of these sheet type phosphor powder particles can be used for making the enhanced light transfer apparatus. This apparatus is made by filling the phosphor powder particles into the polymer films. The degree of polymerization is equal to 100˜500, and an epoxy resin or an organosilicon resin with a molecule quality of 5000˜10000 is used as a membrane material. The molecule quality of polymer is too large, and thus it cannot dissipate the heat produced during the operation of the light emitting diode. The phosphor powder particles filled in the enhanced light transfer structure has a concentration of 1%˜50%, and the most approriate concentration is 15%˜25%, and all light emitting surfaces of this kind of enhanced light transfer powders in the heterostructure has a coating with an even thickness, and the geometric thickness of the coating falls within 50 μ˜200 μ and varies with the sheet phosphor powder particles. The thickness of the enhanced light tranfer layer is usually equal to 80 μ˜120 μ.

In the experiments of the inveniton, several solutions are provided for producing a white light light emitting diode, and the technical parameters are given as follows: the light emitting intensity I≧100 cd and the light emitting efficiency η≧35 lm/w. Compared with traditional garnet phosphor powders, this new phosphor powder has a wider light emitting spectrum and a higher color index R≧85, and thus it can be used extensively in light emitting diodes for professional illuminations.

In summation of the description above, the white light LED, enhanced light transfer powder, phosphor powder and a method of producing phosphor powder in accordance with the present invneiton uses a white light nitride heterostructures that can radiate several color lights, and features a strong yellow color and a yellowish orange color with a very high quantum light emitting efficiency and an enduring light emitting time, and thus the inveniton definitely can overcome the shortcomigns of the prior art white light LED and a method of producing its phosphor powder.

While the invention has been described by means of specific embodiments, numerous modifications and variations could be made thereto by those skilled in the art without departing from the scope and spirit of the invention set forth in the claims.

What is claimed is:

1. A phosphor powder, applicable for a white light LED, and using an oxide of Groups II and III elements in a periodical table as a substrate, and an element having an electron jump in d orbital and f orbital as an activator, and said substrate of phosphor powder is comprised of barium or yttrium aluminate solid solution with a chemical formula of Ba_{α}Y_{3β}Al_{2α+5β}O_{4α+12β}, and a crystal system of its crystal lattice varies with the ratio of barium to yttrium; such that if said substrate is activated by a short wave radiation, the ions of said element will radiate a greenish orange color light mixed with a short wave radiation generated by an indium gallium nitride semiconductor heterostructure to produce a white light.

2. The phosphor powder of claim 1, wherein said a has a value ranging α≧1 or α≦1, and said β has a value ranging β≦1 or β≧1.

3. The phosphor powder of claim 1, wherein said f element and d element added into a compound are: Ce, Pr, Eu, Dy, Tb, Sm, Mn, Ti, or Fe respectively, and having a different oxidation level between +2 to +4.

4. The phosphor powder of claim 1, wherein said short wave radiation has a wavelength λ≦470 nm, and said greenish orange color light has a wavelength λ=530 nm˜610 nm.

5. The phosphor powder of claim 2, wherein said α=0.25 or 0.5 and said β=1, and a crystal lattice of said phosphor powder substrate is substantially a cubic crystal system, and said compound BaAl₂O₄ and Y₃Al₅O₁₂ are activated by Eu^{30 2} and/or Ce⁺³ respectively and melted to form a fluorescent substance.

6. The phosphor powder of claim 2, wherein if α=1 and β≦0.1 in said chemical formula, said phosphor powder substrate has a chemical formula of BaY_{0.3}Al_{2.5}O_{5.2} with a structure of an orthorhomic crystal system; such that when said phosphor powder is activated by Eu⁺² and/or Sm⁺², a narrow band radiation with a half-width peak value Δλ=60-70 nm occurs, so as to assure that said short wave heterostructure is activated to emit a radiation with λ=460 nm and then produce a bluish green color light with chromaticity coordinates x=0.17˜0.22, y=0.45˜0.55.

7. The phosphor powder of claim 1, wherein if a is increased to 1 and β=1 remains unchanged in said chemical formula, said phosphor powder is activated by Ce⁺³, and/or Ti⁺³, and/or Fe⁺³ to emit a wide band radiation with a half-width peak value of Δλ=118˜122 nm, and chromaticity coordinates of x=0.36˜0.42 and y=0.41˜0.44, such that the ratio color temperature of a light activated by a blue color short wave radiation is lowered to T≦5000K.

8. The phosphor powder of claim 1, wherein if α>1.5 in said chemical formula, Gd⁺³ is added into a compound with a structure of an orthorhomic crystal system to substitute the y⁺³ portion in a cation sub crystal lattice, and the radiation peak value of said phosphor powder shifts towards the direction of a long wave (from λ=558 nm to λ=570 nm), while the summation of chromaticity coordinates is increased to Σ(x+y)>0.80.

9. The phosphor powder of claim 1, wherein if α/β≧2, a bright light yellow color is obtained from said compound and a band with a peak value of 440 nm˜480 nm is absorbed, and a reflection occurs at a band of 545 nm˜585 nm.

10. The phosphor powder of claim 1, wherein if Sr⁺² and Ca⁺² are used to substitute the Ba⁺² portion in an anion crystal lattice, a radiation with a narrow band feature is produced by activating Eu⁺² and/or Sm⁺² and/or Mn⁺², and a light is emitted at a half-width peak value Δλ=100˜110 nm, and a band λ=505˜585 nm.

11. The phosphor powder of claim 1, wherein if said phosphor powder is activated by a short pulse of a short wave heterostructure, the afterglow length will fall within a range of t=120 ns˜40 ns and the ratio β/α will be decreased as the range of β/α≧4 is increased.

12. The phosphor powder of claim 1, wherein if 0.05≦α/β≦0.25, said phosphor powder features a dual band light emission.

13. The phosphor powder of claim 1, wherein said substrate is synthesized to a sheet particle state with a plane diameter of 10 to 20 times of unit particle thickness.
